(19) United States
(12) Patent Application Publication
(10) Pub. No.: US 2024/0057631 A1
(43) Pub. Date: Feb. 22, 2024

(54) METHOD OF ROASTING COFFEE BEANS

(71) Applicant: Koninklijke Douwe Egberts B.V., Utrecht (NL)

(72) Inventors: Ian Brown, Hurley (GB); Thomas Imison, Hurley (GB); Luke Acton, Hurley (GB)

(21) Appl. No.: 18/269,251

(22) PCT Filed: Dec. 21, 2021
(86) PCT No.: PCT/EP2021/087012

§ 371 Date: Jun. 22, 2023

(30) Foreign Application Priority Data
Dec. 30, 2020 (GB) 2020704.9

(51) Int. Cl. A23F 5/04

(52) U.S. Cl. CPC A23F 5/04

(57) ABSTRACT

The invention provides a process of roasting whole coffee beans comprising a roasting stage starting at a temperature of the beans of around 80° C., characterised in that the process comprises the step of heating said whole coffee beans such that the temperature of said beans rises from between around 80° C. to around 170° C. at a rate of around 5 to around 18° C./minute.

### TECHNICAL FIELD OF THE INVENTION

The invention relates to a method of roasting unroasted coffee beans and to roasted coffee beans having a minimum gas tight void volume.

### BACKGROUND TO THE INVENTION

It is conventionally accepted that the process of roasting unroasted or “green” coffee beans can be divided into three stages: the first stage being the drying stage, the second stage being the Maillard reactions and Strecker degradation stage and the third stage being the caramelisation and pyrolysis stage. The point at which these stages start and end is not precisely defined, however, the ranges of average temperatures reached by the coffee beans in the roasting chamber at each stage are recognised in the prior art and summarised in the following paragraphs.

### The First Roasting Stage

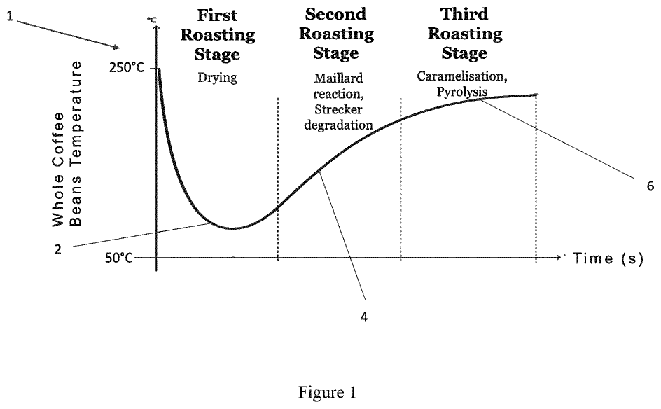

This is the so-called drying phase. This stage takes place whilst the whole unroasted coffee beans are being heated inside the roaster device up to a temperature of the beans around 170° Celsius. During this stage of the roasting process the water within the beans evaporates through an endothermic process, and the temperature within the roasting chamber drops as thermal energy is transferred to the cold beans, before the measured temperature in the roasting chamber increases again (as shown in FIG. 1). Due to the development of gases (mainly steam) an increase in the volume (/size) of the coffee beans can be observed.

### The Second Roasting Stage

This stage takes place when the temperature of the coffee beans in the roasting chamber is between around 170 and around 200° Celsius. The volume (/size) of the coffee beans) continues to increase up to a point where the so-called “first crack” is observable, i.e., the internal pressure within the coffee bean builds up and it is released through a ‘crack’ of the bean structure. At this stage browning of the coffee beans is observable together with the beginning of flavour formation and the formation and release of Volatile Organic Compounds (VOCs). The coffee beans start to exhibit the characteristic aroma complexity of roasted coffee.

### The Third Roasting Stage

The third stage takes place when the temperature of the beans in the roasting chamber reaches above around 200° Celsius. At this stage caramelisation and pyrolysis reactions occur within the coffee beans. Carbon monoxide is released from the coffee beans and the porous structure of the beans is further developed.

The Gas Tight Void Volume (hereinafter “GTVV”) is a known expression used in the coffee sector to indicate the volume of the sealed, gas-tight voids provided within the internal structure of roasted coffee beans—a closed porosity—enabling retention of gases within these voids.

Conventional first roasting stage processes (drying phase) result in relatively low GTVV, which in turn results in higher initial aroma release from the coffee beans after roasting, and therefore a subsequent loss of aroma in the final coffee product.

It would be therefore advantageous to provide a method to manipulate, reduce or slow-down aroma release from roast coffee after roasting, independently of the in-cup flavour result, without the addition of any additives and without the use of expensive pressurized roasting equipment.

In addition, it would be advantageous to provide an easier and less expensive method to manipulate the roasting profile of coffee beans through a simple process conditions change.

Finally, it would be advantageous to provide a method of roasting coffee beans which allows a delay in releasing aroma from roasted coffee beans resulting ultimately in a higher pack aroma at a later stage in the product shelf life.

It is therefore an aim of embodiments of the invention to overcome or mitigate at least one problem of the prior art whether disclosed herein or not.

### SUMMARY OF THE INVENTION

According to a first aspect of the invention there is provided a process of roasting whole coffee beans comprising a roasting stage starting at a temperature of the beans of around 80° C., characterised in that the process comprises the step of heating said whole coffee beans such that the temperature of said beans rises from around 80° C. to around 170° C. at a rate of around 5 to around 18° C./minute.

Preferably the coffee beans at the start of the process are unroasted or green coffee beans.

The inventors have found that a fast first roasting stage (drying phase), i.e., an increase of the bean temperature from an initial temperature of around 80° C. to a temperature of around 170° C., in a period of time of less than 5 minutes, leads to roasted coffee beans with a lower GTVV, and therefore significant loss of aroma.

Conversely, the inventors have surprisingly found that a longer (slower) drying phase of the roasting process, i.e., an increase of the beans temperature from an initial temperature of 80° C. to a temperature of 170° C., in a period of time of more than 5 minutes have been found to result instead in higher GTVV and consequently results in a lower initial aroma release from the roasted beans. The aroma is in fact retained within the roasted coffee bean voids due to their closed porosity and then slowly released in a later stage of the shelf life of the coffee beans. GTVV and the percentage of GTVV (% GTVV, i.e., the measure of the percentage of volume occupied by closed pores within the roasted coffee beans) is measured by helium pycnometry according to the method reported below.

The inventors have also found that through a manipulation of the time-temperature profile during the first roasting stage (from 80° C. up to 170° C.) a measurable effect on the physical structure of the roasted coffee beans (i.e., the Gas Tight Void Volume and moisture content) is provided, resulting an improvement in the perception of the aroma freshness during the product shelf life.

In some embodiments the process may comprise the step of heating said coffee whole beans such that the temperature of said beans rises from 80° C. to 170° C. at a rate of at least 8, 8.5, 9, 9.5 or at least 10° C. per minute. In some embodiments the process may comprise the step of heating said coffee whole beans such that the temperature of said beans rises from 80° C. to 170° C. at a rate of no more than 13.5, 13, 12.5 or no more than 12° C./minute. In some embodiments the process may comprise the step of heating said coffee whole beans such that the temperature of said beans rises from 80° C. to 170° C. at a rate of around 5 to around 15° C./minute, preferably around 6-15° C./minute, 8-13.5° C./minute, 8-13° C./minute, 8-12.5° C./minute, 8.5-12.5° C./minute, 9-13° C./minute, 9-12.5° C./minute, 9-12° C./minute, 9.5-13.5° C./minute, 9.5-13° C./minute, 9.5-12.5° C./minute, 9.5-12° C./minute, more preferably at a rate of around 10-15° C./minute, and even more preferably around 10-13.5, 10-13, 10-12.5 or 10-12° C./minute.

It has been surprisingly found that a temperature range of between 8-13.5° C./minute, in particular, results in an improvement in the perception of the aroma freshness during the product shelf life, thought to be due to an increase in gas tight voids and moisture retention therein.

In some embodiments the process may be carried out at atmospheric pressure (1 atm absolute).

In some embodiments the process may comprise reducing moisture in the whole coffee beans to no more than 5% wt., 3% wt., 2.5% wt., 2% wt., 1.75% wt., 1.5% wt., or no more than 1% wt. In some embodiments the process may comprise reducing moisture in the coffee beans to no more than 5% wt., 3% wt., 2.5% wt., 2% wt., 1.75% wt., 1.5% wt., or no more than 1% wt. during the first roasting stage, second roasting state or third roasting stage, preferably the during the first roasting stage.

In some embodiments the process may further comprise raising the temperature at a rate of around 5 to 15° C./minute between around 170° C. and around 200° C. (i.e. during the second stage of roasting).

In some embodiments the process may further comprise raising the temperature at a rate of around 5 to 23° C./minute between around 200° C. and the end of roast temperature (i.e., during the third stage of roasting). The end of roast temperature may be at least 220, 230, 240 or at least 250° C.

In some embodiments the process may further comprise an incubating or cooling step, after the third roasting stage, in which the roasted bean temperature is lowered to between −10° C. and 40° C.

In some embodiments the incubating step may comprise contacting the roasted whole coffee beans with a cooling agent. Cooling agents may include gases, liquids or solids (such as air, water, gaseous nitrogen, liquid nitrogen, or solid CO₂, for example). Contacting the roasted whole coffee beans may comprise flushing the beans with one or more cooling agents, such as a cooled fluid (which may be a gas, liquid or solid after cooling). In some embodiments said cooled fluid may have a temperature less than 40° C., 30° C., 20° C., 10° C. or less than 8° C. In some embodiments said temperature may be less than 5° C., 2° C., 0° C., −5° C., −10° C., −30° C., −50° C., −70° C., −100° C., −130° C., or −200° C.

In some embodiments the incubating step may last for a period of time in the range of 30 to 300 minutes, particularly 60 to 240 minutes.

In some embodiments the process may comprise packing the roasted whole coffee beans through a standard packing process such as vacuum packing process or modified atmosphere ambient pressure packing process, for the production of vacuum-packed coffee bricks, coffee pouches, bags and/or tins.

According to a second aspect of the invention there is provided a roasted coffee bean comprising a gas tight void volume (GTVV) of at least 30% by volume, and further comprising no more than 5% wt. moisture.

In preferred embodiments the level of moisture is no more than 4% wt., 3.5% wt., 3% wt., 2.5% wt. or less than 2% wt. In some embodiments, the moisture is no more than 1.5% wt. or even no more than 1% wt.

In some embodiments the roasted coffee beans may comprise a bean volume at least 5% lower than the volume of a roasted coffee bean obtained through a conventional roasting process.

In some embodiments the roasted coffee beans may comprise a pycnometry-measured density lower than the pycnometry-measured density of a roasted coffee bean obtained through a conventional roasting process. The density of the beans may be greater than 620 kg/m³, such as in the range of 620 to 650 kg/m³.

According to a third aspect of the invention there is provided roasted coffee beans obtained or obtainable by the process of first aspect of the invention. The roasted coffee beans may comprise the beans of the second aspect of the invention.

### DETAILED DESCRIPTION OF THE INVENTION

In order that the invention may be more clearly understood, embodiments thereof will now be described, by way of example only, with reference to the accompanying drawings of which:

FIG. 1 illustrates the temperature, measured by a thermocouple in the bed of roasted coffee beans in the roasting chamber, as a function of time of a conventional three stage coffee bean roasting process of the prior art;

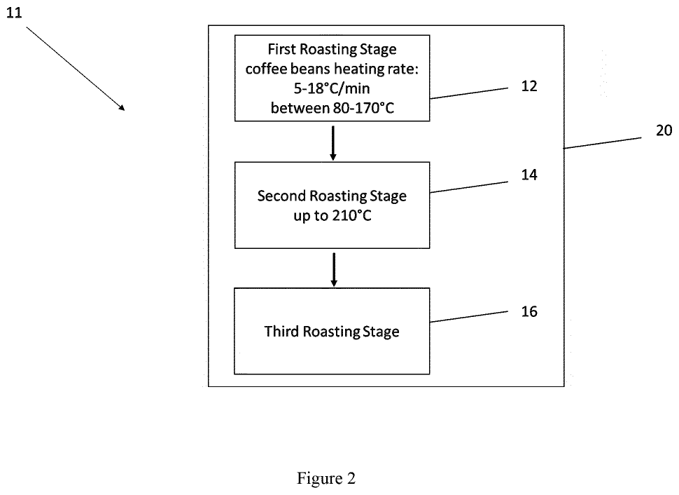

FIG. 2 illustrates a schematic flow diagram (1) of a first embodiment of a coffee beans roasting method of the first aspect of the invention;

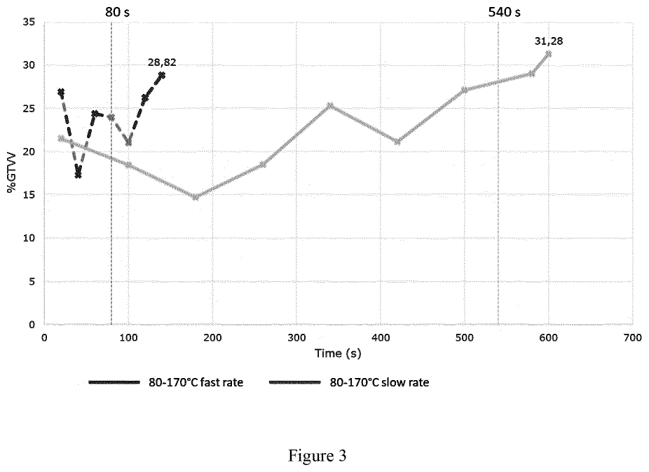

FIG. 3 illustrates the percentage of Gas Tight Voids Volume (% GTVV) over time for the first embodiment of the method of the invention in comparison to embodiments of the prior art.

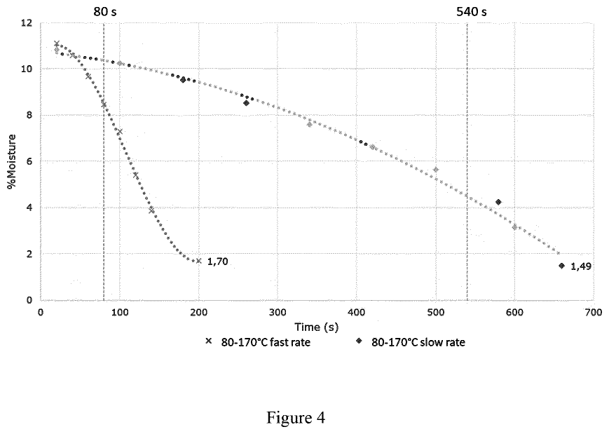

FIG. 4 illustrates the percentage of moisture over time for the first embodiment of the method of the invention in comparison to embodiments of the prior art.

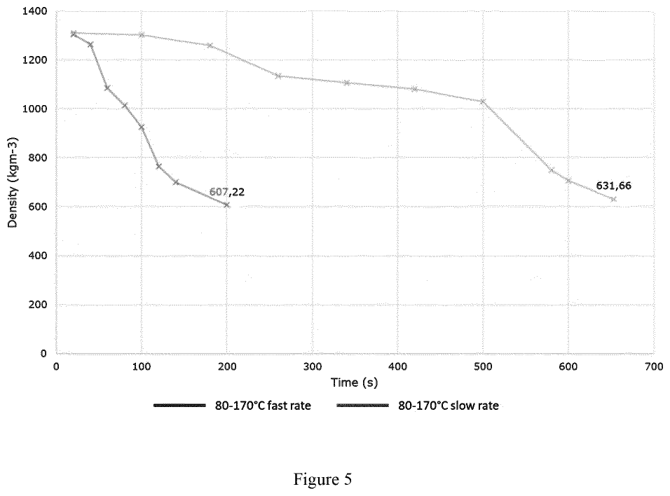

FIG. 5 illustrates the pycnometry-measured skeletal density (kg/m³) over time for a first embodiment of the method of the invention in comparison to embodiments of the prior art.

Referring to the Figures, like numbers represent like components.

Referring firstly to FIG. 1, a temperature over time profile (1) of a three-stage roasting process of the prior art is shown.

A temperature over time profile (1) during roasting presents three roasting stages: First Roasting Stage (2) also known as drying phase, a Second Roasting Stage (4) also known as Maillard reaction and/or Strecker degradation phase starting at around 160° C. to around 170° C. and a Third Roasting Stage (6) also known as caramelisation and/or pyrolysis phase starting at around 200° C.

Unroasted whole coffee beans are loaded into a whole coffee beans roasting apparatus ready for the roasting process of the invention. The unroasted whole coffee beans are not pre-dried or pre-heated whole coffee beans, but pre-dried or pre-heated whole coffee beans are also suitable for the roasting process of the invention. The apparatus is a conventional roasting apparatus such as for instance drum roasters, paddle roasters, fluidised bed roasters, bowl roasters, rotating bowl roasters, tangential roasters, operated either in continuous or batch processing.

The temperature of the roasting apparatus is set at an initial temperature of 250° C. The unroasted or green whole coffee beans (at ambient temperature) are loaded into the apparatus and are progressively heated as thermal energy is transferred from the roasting chamber and the air contained within it, to the beans. During this time, the measured temperature within the bed of beans within the roasting chamber drops as the beans are heated from chilled or ambient temperature and absorb heat from the environment. Subsequently the temperature of the beans (which may also be the temperature within the roaster) rises over time from between around 80° C. to around 170° C., around which point the whole coffee beans enter the second roasting stage.

In this stage, in existing processes the temperature rises between around 170 and around 200° C. at a rate of 9-18° C./minute. The coffee beans reach their final volume and exhibit the characteristic aroma complexity of roasted coffee.

Finally, the whole coffee beans enter the third and final roasting stage where the whole coffee beans are heated at a rate of 15-23° C./minute to reach the final temperature of around 220° C. to around 250° C.

Referring now to FIG. 2 a schematic flow diagram (11) of a first embodiment of a process of roasting unroasted coffee beans of the invention is represented.

The roasting process (20) is performed on whole green (unroasted) coffee beans in a conventional coffee roasting apparatus. The whole green coffee beans are heated in a First Roasting Stage (12) at a rate of 5° C./min to 18° C./min, between a starting temperature assessed around 80° C. and a final temperature around 170° C. The whole coffee beans are then heated up to around 200° C. through a Second Roasting Stage (14) and then to a final roasting temperature of around 220-250° C. of the Third Roasting Stage (16).

The roasting process (20) can be carried out through conventional roasting processes, for example through a hot air roasting process and/or roasting processes using alternative gases such as for example steam, nitrogen and/or carbon dioxide (CO₂) and/or a combination thereof in conventional appliances, for instance drum roasters, fluidised bed roasters, bowl roasters, rotating bowl roasters, tangential roasters, operated either in continuous or batch processing, selecting the preferred temperature-time roasting profile suitable for the specific blend of the green coffee beans used.

After the roasting process (20) is completed, the temperature of the roasted whole coffee beans is manipulated (lowered) and maintained as such over time, in order to improve the organoleptic characteristic of the roasted whole coffee beans. Incubation (or cooling) can be achieved by contact with air, water or other suitable means.

Once the incubating process (cooling) is completed the roasted whole coffee beans are then sent by means of conventional transport/transfer systems (for example pneumatic or mechanical conveying systems such as conveyor belts and infinite screws) to a packing process to be packed through a standard packing process such as, for example, vacuum packing process or modified atmosphere ambient pressure packing process, for the production of vacuum-packed coffee bricks, coffee pouches, bags and/or tins.

### Example 1

Two batches of 450 g each of unroasted washed arabica coffee were roasted using a Rotating Fluidised Bed roaster (RFB-S from Neuhaus-Neotec).

The unroasted whole coffee beans had an initial moisture content of around 10-12% by weight, measured through a conventional method.

The 2 batches were roasted using an algorithm-based slider roasting method where the final roasting degree was measured in CmU and set at 70 (with a CmU tolerance ±5).

Temperature was measured through a conventional thermocouple positioned in the bed of whole coffee beans within the roasting chamber.

The roasting profiles (Temperature over Time trends) for the first roasting stage of each batch of green coffee beans were set as reported in Table 1.

TABLE 1

| | | | End of Roast | |
|---|---|---|---|---|
| | First Stage | | Temperature | |
| | Time in | First Stage | (after Third | Degree |
| Temperature/Time | seconds | Temperature | Roasting | of Roast |
| Profile | (minutes) | Range (° C.) | Stage) (° C.) | (CmU) |
| 80-170° C. fast rate | 80 | 80-170 | 217 | 72 |
| | (1.33) | | | |
| 80-170° C. - slow | 540 | 80-170 | 213 | 69 |
| rate (of the invention) | (9) | | | |

The roasting profile of the invention corresponded to the “80-170° C.—slow rate” profile. The “80-170° C.—fast rate” profile was a profile of the prior art. For both profiles, the Second Roasting Stage raised the temperature from around 170 to around 200° C. over 60 seconds, and the Third Roasting Stage raised the temperature from around 200° C. to the end of roast temperature given in Table 1, over 90 seconds.

After the roasting process was completed, a sample of each batch of roasted whole coffee beans (i.e., a sample of the batch which first roasting stage was set as “80-170° C.—fast rate” roasting profile and one of the “80-170° C.—slow rate” first roasting stage profile of the invention) was transferred to the pycnometry measurement for the determination of the percentage of Gas Tight Voids Volume (% GTVV), as reported below.

### GTVV and % GTVV Measurement

Helium Pycnometry provides the structural density of a solid including any closed pores (surrounded by structure matrix). Density (p) is the quotient of mass and volume of a solid body at a certain temperature. Density is reported as g/ml.

The volume of the each of the samples (fast rate, and slow rate) was determined through adding a known volume of helium gas to a sealed chamber containing the test sample. Helium molecules due to their small size and high diffusion rate, rapidly fill all available open pores. The final pressure in the chamber was used to reverse calculate the volume occupied by each sample. The sample was weighed prior to measurement to allow the sample structural density to be evaluated. Repeated runs were used to ensure repeatability. Measurement was performed at around 20° C.

The percentage of volume occupied by closed pores within each sample (% GTVV) was computed from the skeletal density and the absolute density as

GTVV (%)=ρs×((1/ρs)−(1/ρa))×100%
ρs=Skeletal density
ρa=Absolute density
GTVV=Gas tight void volume

FIG. 3 represents the percentage of Gas Tight Void Volume (% GTVV) as a function of time for the two samples obtained from Example 1.

At the completion of the First Roasting Stage process, i.e., at the end point of the percentage of Gas Tight Void Volume (% GTVV) over time trend shown in FIG. 2, the sample of the invention (slow rate profile)) showed a greater value of % GTVV in comparison to the end point of the same trend for the sample of the prior art (fast rate profile). This end point is the point where both samples have reached the same roasting final temperature and same colour, and have progressed through glass transition and first crack (the “dips” in the GTVV % in FIG. 3) and the roasting process can be stopped.

As can be seen from FIG. 3, a fast rate roasting profile sample presents a lower % GTVV than the slow-rate First Roasting Stage process of the invention. Small increases in % GTVV can result in much bigger beneficial changes in aroma profile in the final product.

Troughs in the % GTVV trends of all three samples analysed were attributed to the glass transition phase and first crack of the coffee beans during roasting.

Therefore, the claimed heating rate range of the First Roasting Stage of green coffee beans according to the invention resulted in an increase in Gas Tight Void Volume % GTVV, without a noticeable change to in-cup taste and provided an overall increase in beneficial aroma characteristics, soon after the roasting.

For the same two samples of Table 1, i.e., the slow rate profile (low temperature long time first roasting stage profile—sample of the invention) and the fast rate profile (high temperature short time first roasting stage profile), the percentage of moisture over time was recorded and the trends are reported in FIG. 4. At the completion of the First Roasting Stage process, which corresponds to the end point of the percentage of moisture over time trend lines, the sample of the invention (slow rate profile) showed a lower level of moisture, which is commonly associated with a higher aroma retention within the whole roasted coffee beans.

Referring finally to FIG. 5, it illustrates the trends of the pycnometry-measured skeletal density (kg/m³) over time for the same two samples of Table 1. At the completion of the roasting process, which corresponds to the end point of the density over time trend lines, the samples of the invention (slow rate profile) showed a higher final density level, which is commonly associated with a lower degree of puffing of the whole coffee beans during roasting (i.e., the beans are more intact, substantially due to an increase in GTVV).

1: A process of roasting whole coffee beans comprising a roasting stage starting at a temperature of the beans of around 80° C., wherein the process comprises the step of heating said whole coffee beans such that the temperature of said beans rises from between around 80° C. to around 170° C. at a rate of around 5 to around 18° C./minute.

2: A process of roasting whole coffee beans according to claim 1 wherein the process comprises the step of heating said whole coffee beans such that the temperature of said beans rises between around 80° C. and around 170° C. at a rate of around 5-15° C./minute.

3: A process of roasting whole coffee beans according to claim 1 wherein the process comprises the step of heating said whole coffee beans such that the temperature of said beans rises between around 80° C. and around 170° C. at a rate of around 6-12° C./minute.

4: A process of roasting whole coffee beans according to claim 1 wherein the process comprises the step of heating said whole coffee beans such that the temperature of said beans rises between around 80° C. and around 170° C. at a rate of 8-12° C./minute.

5: A process of roasting whole coffee beans according to claim 1 wherein the process is carried out at a pressure in the range of 1 to 20 atm.

6: A process of roasting whole coffee beans according to claim 1 wherein the process comprises reducing the moisture content of the whole coffee beans to no more than around 5% wt. of the beans.

7: A process of roasting whole coffee beans according to claim 6 wherein the process comprises the unroasted whole coffee beans moisture to around 1 to 2% wt. of the beans.

8: A process of roasting whole coffee beans according to claim 1 wherein the process comprises raising the temperature of the whole coffee beans from between around 170° C. 170° C. to around 200° C. 200° C., at between around 5 and 15° C./minute.

9: A process of roasting whole coffee beans according to claim 1 wherein the process comprises raising the temperature of the whole coffee beans from between around 200° C. to the end of roast temperature, at between around 5 and 23° C./minute.

10: A process of roasting whole coffee beans according to claim 1 wherein the process further comprises an incubating or cooling step in which the final roasted bean temperature is lowered to between around 10° C. and 40° C.

11: A process of roasting whole coffee beans according to claim 10 wherein the incubating or cooling step comprises contacting the whole coffee beans with a cooling agent.

12: A process of roasting whole coffee beans according to claim 11 wherein the cooling agent is selected from liquid nitrogen or solid CO₂.

13: A process of roasting whole coffee beans according to claim 11 wherein contacting the roasted whole coffee beans comprises flushing the beans with the one or more cooling agents.

14: A process of roasting whole coffee beans according to claim 10 wherein the incubating step lasts for between 30 and 300 minutes.

15: A process of roasting whole coffee beans according to claim 1 wherein the process comprising packing the roasted whole coffee beans.

16: Roasted coffee beans comprising a gas tight void volume (GTVV) of at least 30% by volume and further comprising less than 5% wt. moisture, preferably no more than around 2.5% wt. moisture.

17: Roasted coffee beans according to claim 16 comprising a pycnometry-measured density in the range of 620 to 650 kg/m³.

18: Roasted coffee beans comprising a gas tight void volume (GTVV) of at least 30% by volume and further comprising less than 5% wt. moisture, obtained by the process of claim 1.

19: A process of roasting whole coffee beans according to claim 1 wherein the process is carried out at a pressure in the range of 1 to 5 atm.

20: A process of roasting whole coffee beans according to claim 1 wherein the process comprises reducing the moisture content of the whole coffee beans to no more than around 2.5% wt. of the beans.
